(19) United States
(12) Patent Application Publication
(10) Pub. No.: US 2008/0210647 A1
(43) Pub. Date: Sep. 4, 2008

(54) DRYING PLATFORM SYSTEM AND POTTERY BAT

(76) Inventors: Andrew Hornak, (US); Mary Lou Hornak, (US)

Correspondence Address: Andrew Hornak, 68 Linscott Rd., York, ME, 03909, US

(21) Appl. No.: 11/940,224

(22) Filed: Nov. 14, 2007

Related U.S. Application Data
(60) Provisional application No. 60/866,214, filed on Nov. 16, 2006.

(51) Int. Cl. F26B 19/00

(52) U.S. Cl. 211/13.1

(57) ABSTRACT

The invention pertains to a Drying Platform System with breathable top attached to a carrier base. The carrier base allows passage of air or gas through the breathable top. The carrier base includes features to allow snap or friction attachment to apposing surface, were simple tool is used to release. The carrier base provides precision positioning on a rotating devise. The drying platform can be a standalone device or pottery bat which attaches to a pottery wheel head. The drying platform system can be of any size or shape. The top when shaped concave or convex, allows part-shape formation. Carrier base construction provides a rigid structure to the top to prevent twisting and provide a light weight assembly reducing mailing costs. When the carrier base is used with a non-breathable top it creates a structure which when used as a pottery bat has all the same functionally without breathable function.

### CROSS-REFERENCE TO RELATED APPLICATION

This application claims priority under 35 USC §119 to U.S. Provisional Patent Application No. 60/866,214 Filed on Nov. 16, 2006.

### FIELD of the Invention

The invention relates to equipment for use on a wheel head of a Potters wheel or as a standalone forming and drying platform. More specifically, it relates to a drying platform system-pottery bat.

### BACKGROUND OF THE INVENTION

The equipment is typically used by Sculptures and Potters, but can be used for any product requiring even drying. These pieces of work are typically fabricated of clay or other materials which require drying. It is preferred to have the pieces dry evenly to prevent cracking or other imperfections, which are reasons for rejection of parts and loss of work.

Current methods of drying require the pieces to be covered to slow the drying process to help prevent rejection of parts. The covering of the parts slows drying and increases the time the pieces need to stand before additional work can be completed. This lengthens the production cycle time.

Parts may also be made or placed on (gypsum-based) plaster. Plaster platforms have the ability to help in this drying process by absorbing some of the moisture. Draw backs of plaster is its weight which makes it difficult for some to move parts around and that plaster can chip and flake contaminating parts placed on the plaster. The weight also causes high shipping cost for plaster platforms when sold by mail.

Potters also use pottery bats to form pieces on a potter's wheel. Potters attach a plaster, plastic, wood or wood composite to the top of the wheel head. Potters' bats are attached to the wheel head by means of clay, grommet, pin, pin-slot, holes, hole-slot, clamp, or combination of several of these methods. These methods at times are inadequate and require resetting to secure the bat to the wheel head of the potters wheel. When this happens during the throwing or forming of a piece, the piece may not re-center on the wheel head causing rejection of these part. Some of the typical materials used to fabricate a bat can warp or deteriorate causing an uneven surface which is undesirable when throwing or forming a part. Additional trimming or cleaning is then required on these parts.

Centering and attaching a potters bat on the wheel head of the pottery wheel can take considerable time and effort. This is even more difficult when using clay to attach the bats to the pottery wheel head. Getting the bat level can take additional effort. Leveling takes skill and if not done properly, work pieces are lost. This can be very difficult to someone new to the pottery wheel.

### SUMMARY OF THE INVENTION

The invention provides a simple means of attachment of a drying platform to the pottery wheel head. The invention provides a drying surface for even drying of parts fabricated from clay or any other material requiring an even drying. This invention can be used as part of drying platform system-pottery bat or as a standalone drying system.

When used on a pottery wheel head the invention provides simple attachment and centering to the wheel head. It also provides quick and transportable attachment to multiple wheel heads.

The invention improves the production time by reducing the drying cycle of constructed parts on the drying platform. It also reduces the finishing time of the constructed parts attached to the surface of the drying platform.

The invention provides a means for new corners to the art of using a potter's wheel to concentrate on the throwing and forming of pieces rather then the attachment of a bat to the pottery wheel head.

Another object of the invention is the reduction of weight allowing easier part movement on the shop floor and reduced shipment costs over (gypsum-based) plaster bats.

### BRIEF DESCRIPTION OF THE DRAWINGS

The accompanying drawings show the embodiment of the invention together with invention variations and modifications. Along with description used to explain the principles of the invention, in the drawings.

FIG. 1, Shows general functional view on a potter's wheel head with primary elements.

FIG. 2 Shows the detachment of primary elements of FIG. 1 and the elements of the drying platform system to the pottery wheel head.

FIGS. 3 & 3A, Show cross-section of the drying platform FIGS. 1 & 2.

FIG. 4, Shows exploded view of elements.

FIG. 5, Shows bottom view of the drying platform highlighting the corresponding attachment points and details which relate to the adapter plate FIG. 2.

FIG. 6, Show two exploded views of the attachment of the drying platform system. One with and one without the centering button.

FIG. 7, Shows exploded view of an alternate shaped drying platform.

FIG. 8, Shows alternate design with raised surface for forming a part using the drying platform as the form.

FIG. 9 Shows detail of the use of the drying platform as a standalone unit on a table surface.

### DETAILED DESCRIPTION

The figures show the embodiment and detailed facets of the invention.

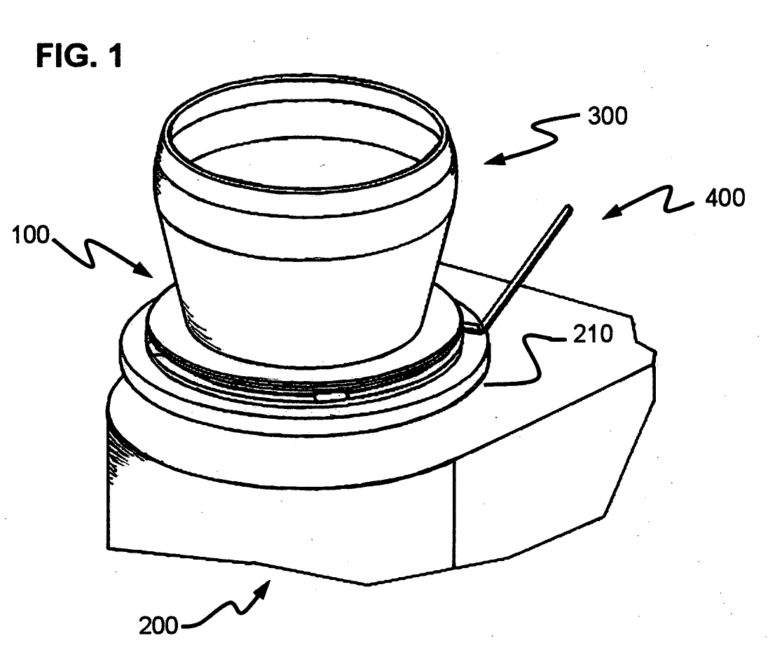

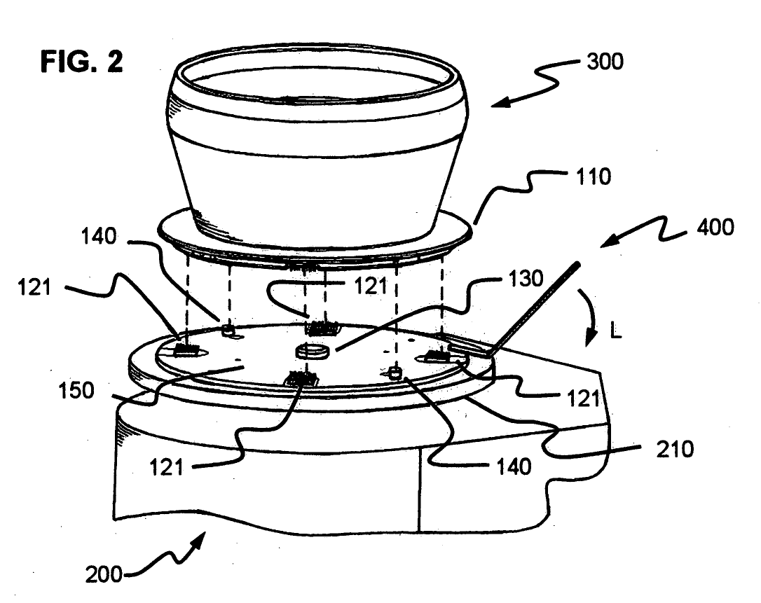

Referring now to FIG. 1, the drawing shows a shaped part 300 more specifically in this figure a pot 300. The pot 300 is shown on the drying platform system 100 which is shown attached to the wheel head 210 of the pottery wheel 200. Also shown is a simple leverage tool 400 to detach the drying platform 110 of FIG. 2 from the wheel head 210 of the pottery wheel 200.

FIG. 2 Shows the pot 300 and drying platform 110 in FIG. 1 detached from the pottery wheel 200, more specifically, detached from the adapter plate 150. The drying platform system 100 is made-up of the two primary elements, drying platform 110 and the adapter plate 150. The elements shown in FIG. 2 are as follows, the pottery wheel head 210, adapter plate 150, centering button 130, snaps 121, bolts 140, simple leverage tool 400, drying platform 110 and pot 300. Using the simple leverage tool 400 in a down-ward motion L causes the snaps 121 to release, allowing the removal of the drying platform 110 and the pot 300 to be released from the adapter plate 150. The adapter plate 150 is attached to the wheel head 210 by using standard bolts 140 normally supplied with a pottery wheel 200.

FIG. 2 Shows other primary elements of the functional attachment. The centering button 130 is used to allow the user to center the drying platform 110 on the wheel head 210. More specifically the centering button 130 allows a user to center on multiple wheel heads 210 or back onto the same wheel head 210. This centering functionality allows the user to remove and then work on a part 300 at a later time while still maintaining the part 300 in a center position on the wheel head 210. This allows the user to start a new part 300 without losing production time.

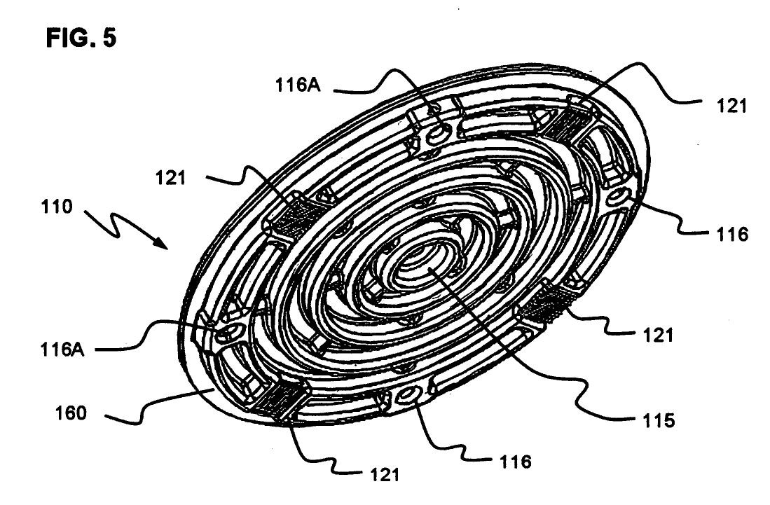

The snaps 121 shown in FIG. 2 allow the user to attach the drying platform 110 firmly to the adapter plate 150 on the wheel head 210 with little force. Not shown in this view are apposing snaps 121 on the bottom side of the drying platform 110 which are shown in FIG. 5. Attachment using snaps 121 reduces the overall time required to attach and center the drying platform 110 over the present methods that are in use. The view shows four snaps 121 but can be more or less than four, depending on drying platform 110, size. The bolts 140 are used to attach the adapter plate 150 to the wheel head 210, but also provide positioning for ease of snap 121 locating. The adapter plate 150 can be formed as a single unit and formed integral as part of the wheel head 210. FIG. 2 shows the attachment as a separate unit more specifically an adapter plate 150 which is attached to the wheel head 210. This allows potters to utilize the drying platform 110 on existing pottery wheels 200.

The method of using snaps 121 to attach the drying platform 110 is not limited to this use alone. This means of attachment can be used for other attachment devices used on a wheel head 210, such as platform devices used for spraying, sanding, detailing, etc.

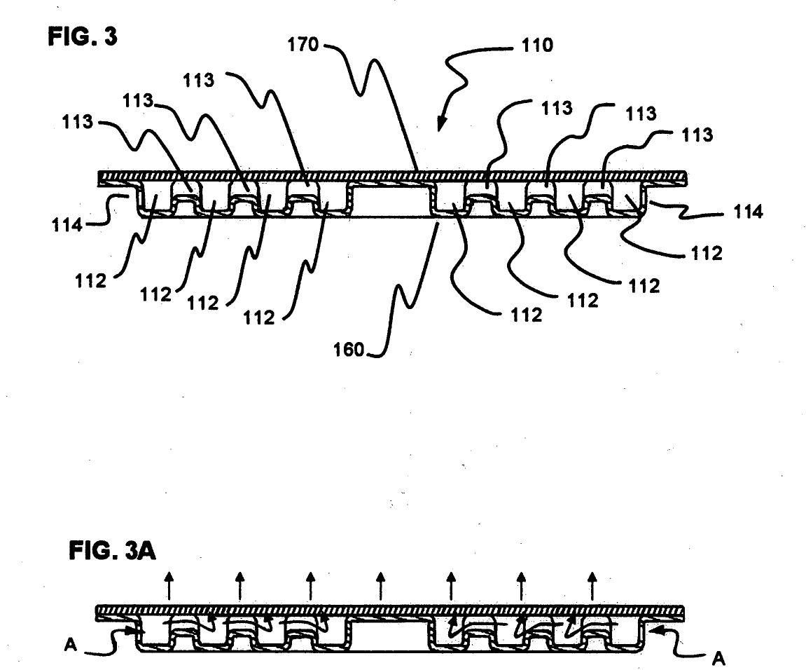

FIG. 3 Shows a cross section view of the drying platform 110 and details of the drying platform elements. The top surface 170 is made from filter material, more specifically of plastic filter type material ranging 15 to 100 micron, pore size. Other filter or porous materials can also work as the top surface 170, but preference would be to use materials that are not affected by water used in the formation of parts 300. The pores in the top surface 170 allows air A to flow through as show in FIG. 3A and allows drying to the bottom surface of the part 300 see FIG. 1. The carrier base 160 is fabricated with the following elements to provide passage ways for air flow A through the carrier base 160. More specifically the carrier base 160 has series of channels 112 and passage-ways 113. The passage-ways 113 allow openings between the channels 112. The air A is allowed to enter through a series of holes 114 or openings around the out side of the carrier base 160. The air A can be moved by convection, natural flow or can be forced to quicken the drying time and reducing production time to fabricate parts.

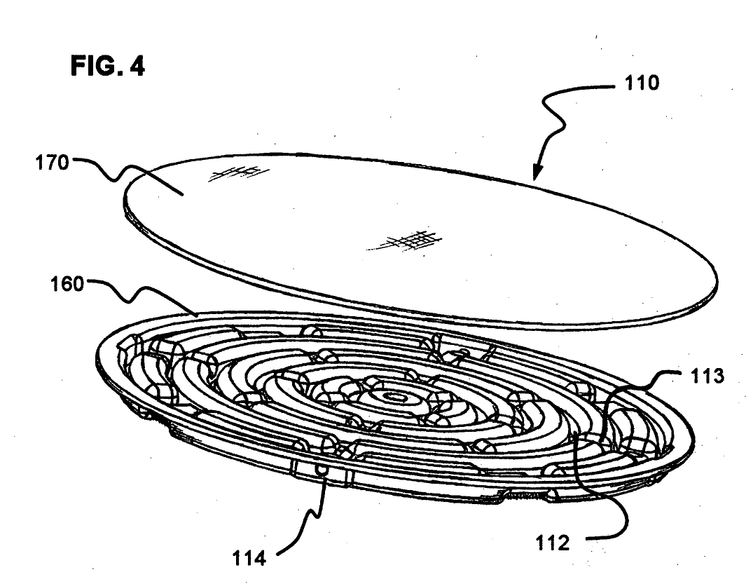

FIG. 4 shows an exploded view of the drying platform 110 with details of air channels 112 and passage ways 113. Also seen in this detail is one of the hole openings in the outer surface of the carrier base 160, the holes or opening around the carrier base allow air A to enter into the outer channel 112 and then pass from channel 112 to channel 112 through cross over passage-ways 113. As shown in FIG. 3A and FIG. 4. The formation or shape of the carrier base 160 due to the formation of these channels 112 and features creates a rigid but light assembly. This provides a tremendous weight advantage over plaster bats while providing comparable drying and superior surface finish over plaster and other material bats. The drying platform 110 will easily support weights of 50-lbs or more while only adding fractionally to overall handling weight. The flexing seen in other bats while handling is almost completely eliminated due to the carrier bases' 160 channel 112 structural formation of carrier base 160.

FIG. 5 This view shows the bottom side of the drying platform 110 and the corresponding attachment element details. The snaps 121 FIG. 5 are located to make contact with FIG. 2 snaps 121 located on the adapter plate 150 also of FIG. 2. Recesses in the bottom of the carrier base 160, one slotted 116A with apposing diameter recess 116 help locate snaps 121 of the carrier base 160 and adapter plate 150 of FIG. 2. These recesses 116 & 116A accept the bolt 140 heads of FIG. 2 the recesses and prevent the bolts 140 from interfering with the placement of drying platform 110. This view also shows a second set of recess areas 116′ & 116A′ set at 90 degrees from the first set and centered about the center locating recess 115. The center locating recess 115 is precision formed or fabricated to provide precise locating of button 130 of FIG. 2.

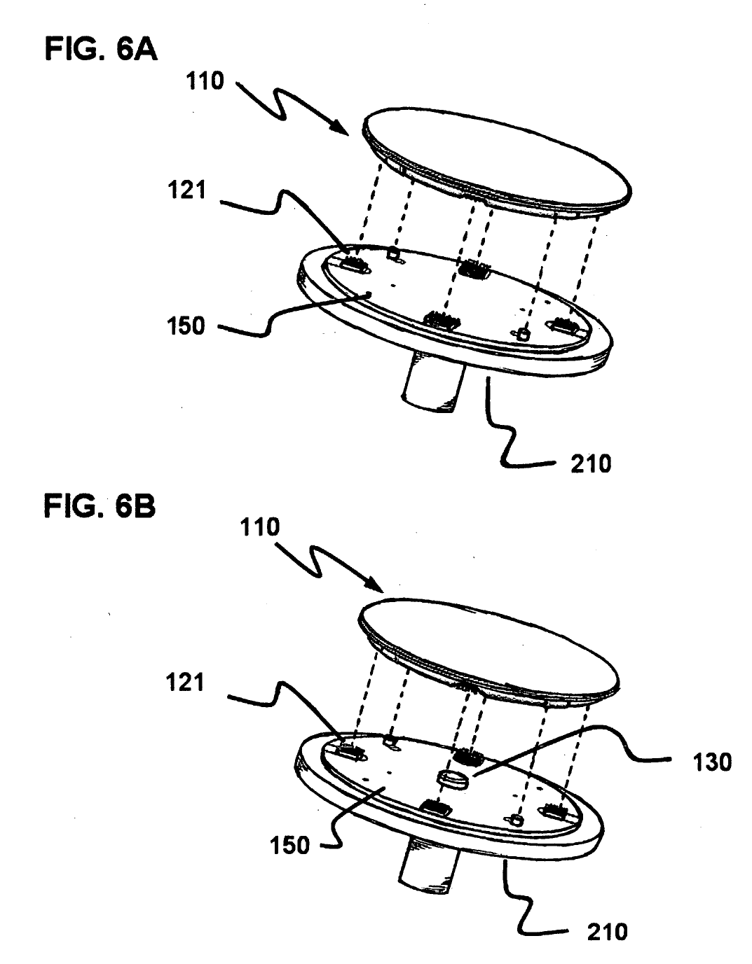

FIG. 6 Shows two exploded views of the drying platform system 100 of FIG. 1. The centering button 121 is shown in one view B, the other view A without the button 121. The drying platform 110 can be used in either A or B but is preferred to be used with the button view B.

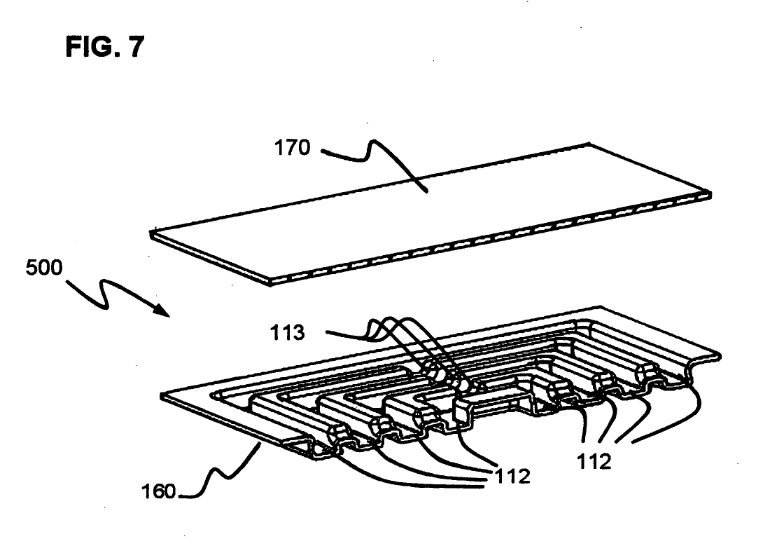

FIG. 7 Shows exploded view of an alternate shaped drying platform 500 the elements are labeled with common numbering as defined in FIGS. 3 & 4. The top 170 is porous material, the carrier base 160 which shows the channels 112 and the crossover passage-ways 113 between channels 112. The drying platform can be of any shape or size.

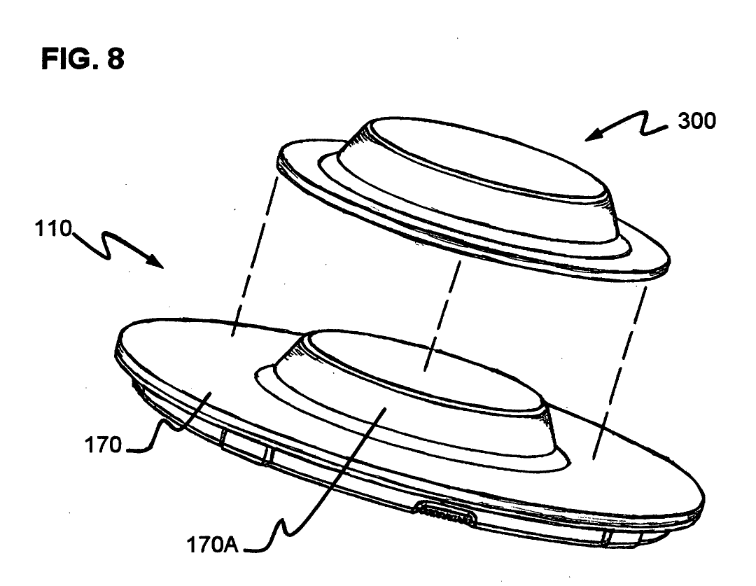

FIG. 8 Shows an alternate drying platform 110 which has a raised surface. The raised surface 170A or formation of the top 170 of the platform 110 can also be shaped concave into the top surface 170. This view is shown as a variation to the drying platform 110, regardless of shape or size the features described in this invention would apply. The part 300 would be formed over or into a shape 170A which would be formed as part of the top surface 170. This method would allow same size and shape parts 300 to be easily formed and shaped.

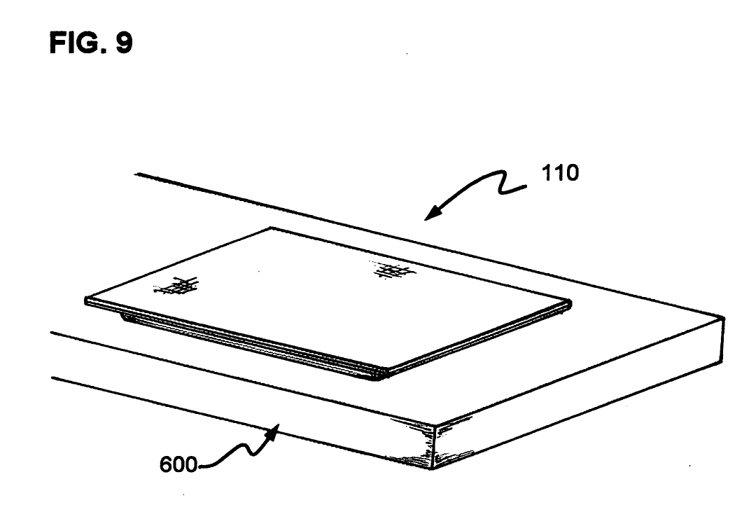

FIG. 9 Shows alternate use of a drying platform 110 resting on a bench top 600, were it can be used for any type of sculpturing or forming of parts 300. In all cases the part 300, FIGS. 1, 2, & 8 would not require removal from the top surface 170 of the drying platform 110 by cutting or lifting of part 300 from the drying platform 110. Cutting and lifting is normal practice of removal of part 300 from pottery wheel head 210, this can damage part 300 requiring repair or rejection. The inventions drying process, releases the part 300 as it dries on the drying platform 110, leaving a clean smooth surface on the bottom of part 300 overcoming these issues.

While there have been shown and described and pointed out fundamental novel features of the invention as applied to preferred embodiments thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto. Furthermore, in the claims means-plus-function clauses are intended to cover the structures described herein as performing the recited function and not only structural equivalents, but also equivalent structures. Thus although a nail and a screw may not be structural equivalents in that a nail employs a cylindrical surface to secure wooden parts together, whereas a screw employs a helical surface, in the environment of fastening wooden parts, a nail and a screw may be equivalent structures.

What is claimed is:

1. A Drying Platform System comprising:
Breathable top having pores for passage of gas there through and a carrier base attached to the breathable top. The carrier base having a bottom surface dimensioned for attachment of apposing surface or device.

2. The Drying Platform System in claim 1 with an attachment means formed or attached to the carrier base to allow firm snap attachment to an adapter or surface.

3. The Drying Platform System in claim 1 with an attachment means to firmly attach to a pottery wheel head by means of an adapter or as part of a pottery wheel head.

4. The Drying Platform System in claim 1 which is used as a pottery bat for attachment to a pottery wheel head.

5. The Drying Platform System in claim 2 which firmly attaches to a surface, requiring the use of a magnitude of force to release from attachment surface.

6. The Drying Platform System in claim 5, which can release from attached surface with a simple tool, such as a pry bar.

7. The Drying Platform System in claim 1, with a top which is breathable.

8. The Drying Platform System in claim 7, which the breathable filter top, has a pore size range of 15 to 100 microns in size.

9. The Drying Platform System in claim 8, which the top surface is breathable plastic material.

10. The Drying Platform System in claim 1, with an attached carrier base which creates rigid support for a normally flexible top.

11. The Drying Platform System in claim 10, which the carrier base is formed to allow passage of air or other gases to pass through its top surface.

12. The Drying Platform System in claim 11, which the carrier base has passage-ways and holes or openings to allow air or gases to pass from channel to channel.

13. The Drying Platform System in claim 1, when attached to the base creates a light weight, rigid structure preventing twist or warpage.

14. The Drying Platform System in claim 13, when attached to the base creates a light weight assembly allowing reduction of mailing costs.

15. The Drying Platform System in claim 1, which has a solid but all other features to create a rigid attachable platform.

16. The Drying Platform System in claim 15, which can be attached to a pottery wheel by means of snap or friction interlocking where adapter or wheel head have same apposing function.

17. The Drying Platform System in claim 1, which has a recessed area in carrier base to accept projection for positioning of the platform to a mating surface.

18. The Drying Platform System in claim 17, when positioned over projection on an adapter or pottery wheel head, the projection centers the platform to the center of the wheel head.

19. The Drying Platform System in claim 17, recess with precision location of a projection and provide a repeated centering of platform on the same wheel head or from one pottery wheel head to another pottery wheel.

20. The Drying Platform System in claim 1, which can be of any shape or size and the top flat.

21. The Drying Platform System in claim 20, with a formed top surface which has a shape in the surface to create a means of forming the same part shape and size multiple times.

22. The Drying Platform System in claim 21, with a centered circular formed shape which can be used to shape parts while attached and turning on a pottery wheel.

23. The Drying Platform System in claim 22 can be a concave or convex formed projection on top surface.

24. The Drying Platform System in claim 21 can be a concave or convex formed projection on the top surface.

25. A Pottery Bat comprising the drying platform system of claim 1.

26. The Pottery Bat in claim 25, having recessed cavities on the bottom carrier base configured to accept standard pottery wheel head bolts with aligned apposing snaps. One set of snaps located on the bottom of carrier base and one set located on and adapter or pottery wheel head.

27. The Pottery Bat in claim 26, with snaps are located on the bottom of the carrier base align with the snaps on adapter or wheel head while attachment is made.

28. The Pottery Bat in claim 27, with snaps in the form of apposing interlocking features requiring a force to separate.

29. The Pottery Bat in claim 28, with snaps located to provide attachment to adapter or a pottery wheel head, where any number can be used, determined by size of platform in use.

30. The Pottery Bat in claim 29, were the means of attachment can be used on other types of equipment requiring attachment to a pottery wheel head.

31. The Pottery Bat in claim 29, were the means of attachment can be used on other types of equipment requiring attachment to adapter.

32. The Drying Platform System in claim 2, were the means of attachment can be used on other types of equipment requiring attachment to a pottery wheel head.

33. The Drying Platform System in claim 2, were the means of attachment can be used on other types of equipment requiring attachment to adapter.
